(19) United States
(12) Patent Application Publication
(10) Pub. No.: US 2018/0182605 A1
(43) Pub. Date: Jun. 28, 2018

(54) ALIGNING ION OPTICS BY APERTURE SIGHTING

(71) Applicant: Thermo Finnigan LLC, San Jose, CA (US)

(72) Inventors: Nicholas T. MOLLISON, Austin, TX (US); Jaime A. CARRERA, Austin, TX (US); Joshua T. MAZE, Round Rock, TX (US); Scott T. QUARMBY, Round Rock, TX (US)

(73) Assignee: Thermo Finnigan LLC

(21) Appl. No.: 15/389,118

(22) Filed: Dec. 22, 2016

(51) Int. Cl. H01J 49/06

(52) U.S. Cl. CPC H01J 49/067

(57) ABSTRACT

A mass spectrometry system includes an ion optics stack defining a central longitudinal axis. The ion optics stack includes a circular lens aperture of a first diameter and a circular alignment target having a second diameter. The second diameter is less than the first diameter. The circular alignment target is positioned such that when the ion optics stack is in alignment, the circular lens aperture and circular alignment target appear concentric to an unaided viewer when viewed along the central longitudinal axis of the ion optics stack.

### FIELD

The present disclosure generally relates to the field of mass spectrometry including aligning ion optics by aperture sighting.

### INTRODUCTION

Mass spectrometry is an analytical chemistry technique that can identify the amount and type of chemicals present in a sample by measuring the mass-to-charge ratio and abundance of gas-phase ions. Typically, the ions travel along a path from an ion source to a mass analyzer. Precise alignment of ion optical components along that path is required to get good transmission, which is necessary for sufficient ions to reach the mass analyzer for analysis. Typically, ion optics must be parallel and the centers aligned within ˜50 μm.

Previously, precise alignment required machining parts to high tolerances or the use of complex assembly jigs. Precise machining can be expensive, and using assembly jigs makes it difficult to replace parts in the field where the jig is not readily available.

As such, there is a need for new methods to accurately and precisely align ion optics components without the expense of precision machined parts or complex assembly jigs.

### SUMMARY

In a first aspect, a mass spectrometry system can include an ion optics stack. The ion optics stack can define a central longitudinal axis and can include a circular lens aperture of a first diameter and a circular alignment target having a second diameter. The second diameter is less than the first diameter. The circular alignment target can be positioned such that when the ion optics stack is in alignment, the circular lens aperture and circular alignment target appear concentric to an unaided viewer when viewed along the central longitudinal axis of the ion optics stack.

In various embodiments of the first aspect, the alignment target can be a circular mark on an interior surface of the mass spectrometry system.

In various embodiments of the first aspect, the circular lens aperture and the circular alignment target can have an Inner Circle Percent of not less than about 50%, such as not less than about 80%.

In various embodiments of the first aspect, when the ion optics stack can be in alignment, the circular lens aperture and the circular alignment target can have an Offset Ratio of not less than about 0.4, such as not less than about 1.2.

In various embodiments of the first aspect, when the ion optics stack can be in alignment, the circular lens aperture and the circular alignment target have a Gap Offset Ratio not less than about 4, such as not less than about 6.

In various embodiments of the first aspect, the ion optics stack can further include a second lens aperture and the circular lens aperture, the second lens aperture, and the circular alignment target appear concentric when viewed along the ion optics stack when the ion optics stack is in alignment.

In a second aspect, a method for aligning an ion optics stack within a mass spectrometry system can include inserting the ion optics stack into the mass spectrometry system. The ion optics stack can include a circular alignment guide and defining a central longitudinal axis. The mass spectrometry system can include a circular alignment target. The method can further include adjusting the alignment of the ion optics stack until the alignment guide and the alignment target appear concentric when viewed by an unaided viewer along the central longitudinal axis of the ion optics stack.

In various embodiments of the second aspect, adjusting the alignment of the ion optics stack can include adjusting one or more alignment screws.

In various embodiments of the second aspect, the method can further include securing the ion optics stack in the aligned position.

In various embodiments of the second aspect, the circular alignment guide and the circular alignment target can have an Inner Circle Percent of not less than about 50%, such as not less than about 80%.

In various embodiments of the second aspect, adjusting the alignment of the ion optics stack can include adjusting the alignment until the circular alignment guide and the circular alignment target have an Offset Ratio of not less than about 0.4, such as not less than about 1.2.

In various embodiments of the second aspect, adjusting the alignment of the ion optics stack can include adjusting the alignment until the circular alignment guide and the circular alignment target have a Gap Offset Ratio of not less than about 4, such as not less than about 6.

In various embodiments of the second aspect, the circular alignment guide can be a lens aperture of the ion optics stack. In particular embodiments, the circular alignment target can be a lens aperture of a second ion optics stack. In particular embodiments, the circular alignment target can be a circular mark on an interior surface of the mass spectrometry system.

In a third aspect, an ion optics stack can have a first circular aperture and a second circular aperture displaced from one another along a length of the ion optics stack. The ion optics stack can define a central longitudinal axis. A method of aligning the ion optics stack can include adjusting the alignment of the ion optics stack until the first circular aperture and the second circular aperture appear concentric when viewed by an unaided viewer down the central longitudinal axis of the ion optics stack.

In various embodiments of the third aspect, the first circular aperture and the second circular aperture can have an Inner Circle Percent of not less than about 50%, such as not less than about 80%.

In various embodiments of the third aspect, adjusting the alignment of the ion optics stack can include adjusting the alignment until the first circular aperture and the second circular aperture have an Offset Ratio of not less than about 0.4, such as not less than about 1.2.

In various embodiments of the third aspect, adjusting the alignment of the ion optics stack can include adjusting the alignment the first circular aperture and the second circular aperture have a Gap Offset Ratio of not less than about 4, such as not less than about 6.

In various embodiments of the third aspect, the first circular aperture can be a first lens aperture of the ion optics stack.

In various embodiments of the third aspect, the second circular aperture can be a second lens aperture of a second ion optics stack.

### DRAWINGS

For a more complete understanding of the principles disclosed herein, and the advantages thereof, reference is now made to the following descriptions taken in conjunction with the accompanying drawings and exhibits, in which:

FIG. 1 is a block diagram of an exemplary mass spectrometry system, in accordance with various embodiments.

FIGS. 2A and 2B are diagrams illustrating the alignment of ion optics components, in accordance with various embodiments.

FIG. 3A is a drawing illustrating an exemplary ion optics stack within an exemplary mass spectrometer, in accordance with various embodiments.

FIG. 3B is a drawing illustrating an alternate arrangement of alignment screws, in accordance with various embodiments.

FIG. 4 is a drawing illustrating a misaligned ion optics stack, in accordance with various embodiments.

FIG. 5 is a drawing illustrating a properly aligned ion optics stack, in accordance with various embodiments.

FIGS. 6 and 7 are flow diagram illustrating exemplary methods of aligning ion optics stacks, in accordance with various embodiments.

FIGS. 8A, 8B, 8C, and 8D are diagrams illustrating various degrees of misalignment between two concentric circles, in accordance with various embodiments.

FIG. 9 is a graph showing assessments of alignment as a function of displacement and Inner Circle Percent.

FIG. 10 is a graph showing assessments of alignment as a function of displacement and Gap Offset Ratio.

FIG. 11 is a graph showing assessments of alignment as a function of displacement and Offset Ratio.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DESCRIPTION OF VARIOUS EMBODIMENTS

Embodiments of systems and methods for ion isolation are described herein and in the accompanying exhibits.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

### Mass Spectrometry Platforms

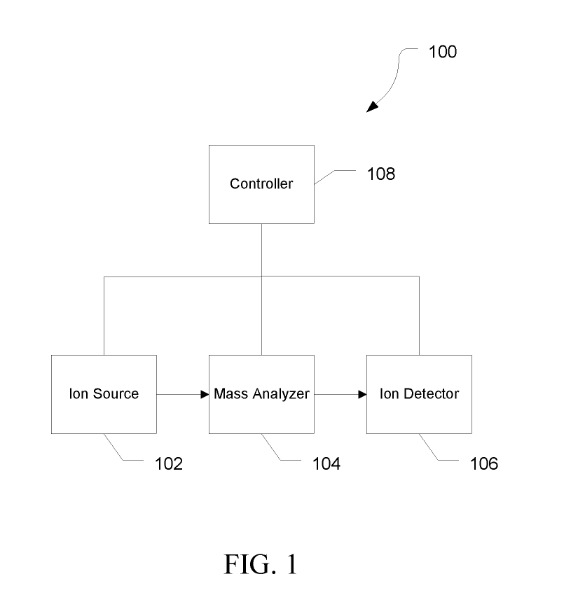

Various embodiments of mass spectrometry platform 100 can include components as displayed in the block diagram of FIG. 1. In various embodiments, elements of FIG. 1 can be incorporated into mass spectrometry platform 100. According to various embodiments, mass spectrometer 100 can include an ion source 102, a mass analyzer 104, an ion detector 106, and a controller 108.

In various embodiments, the ion source 102 generates a plurality of ions from a sample. The ion source can include, but is not limited to, a matrix assisted laser desorption/ionization (MALDI) source, electrospray ionization (ESI) source, atmospheric pressure chemical ionization (APCI) source, atmospheric pressure photoionization source (APPI), inductively coupled plasma (ICP) source, electron ionization source, chemical ionization source, photoionization source, glow discharge ionization source, thermospray ionization source, and the like.

In various embodiments, the mass analyzer 104 can separate ions based on a mass to charge ratio of the ions. For example, the mass analyzer 104 can include a quadrupole mass filter analyzer, a quadrupole ion trap analyzer, a time-of-flight (TOF) analyzer, an electrostatic trap (e.g., ORBITRAP) mass analyzer, Fourier transform ion cyclotron resonance (FT-ICR) mass analyzer, and the like. In various embodiments, the mass analyzer 104 can also be configured to fragment the ions using collision induced dissociation (CID) electron transfer dissociation (ETD), electron capture dissociation (ECD), photo induced dissociation (PID), surface induced dissociation (SID), and the like, and further separate the fragmented ions based on the mass-to-charge ratio.

In various embodiments, the ion detector 106 can detect ions. For example, the ion detector 106 can include an electron multiplier, a Faraday cup, and the like. Ions leaving the mass analyzer can be detected by the ion detector. In various embodiments, the ion detector can be quantitative, such that an accurate count of the ions can be determined.

In various embodiments, the controller 108 can communicate with the ion source 102, the mass analyzer 104, and the ion detector 106. For example, the controller 108 can configure the ion source or enable/disable the ion source. Additionally, the controller 108 can configure the mass analyzer 104 to select a particular mass range to detect. Further, the controller 108 can adjust the sensitivity of the ion detector 106, such as by adjusting the gain. Additionally, the controller 108 can adjust the polarity of the ion detector 106 based on the polarity of the ions being detected. For example, the ion detector 106 can be configured to detect positive ions or be configured to detected negative ions.

### Ion Optics Element Alignment

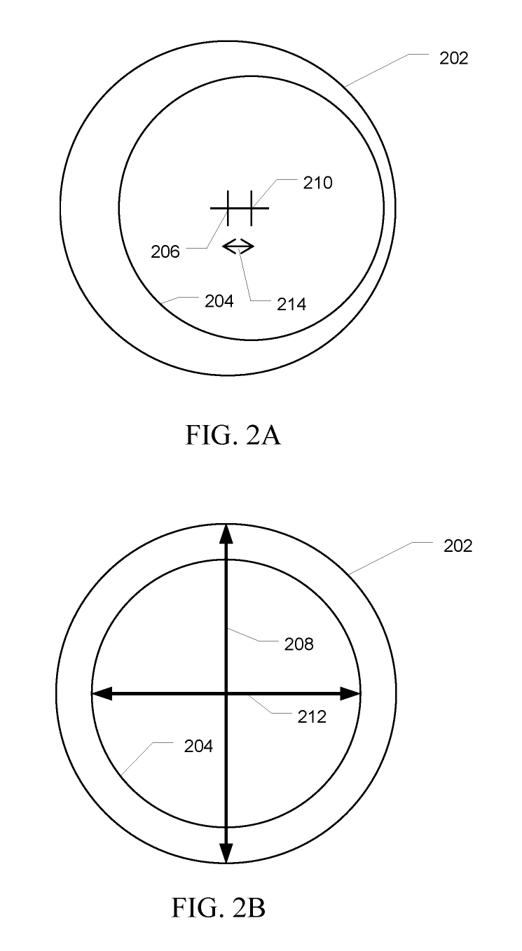

FIGS. 2A and 2B are illustration simulating the view corresponding to ion optics when viewed from an alignment position in an unaligned state and an aligned state respectively. The view consists of an alignment guide 202 and an alignment target 204. The alignment guide 202 can have a center 206 and a diameter 208 and the alignment target 204 can have a center 210 and a diameter 212. Diameter 208 can be greater than diameter 212. In various embodiments, the alignment guide 202 can be a circular aperture of a first ion lens and the alignment target 204 can be the circular aperture of a second ion lens. Alternatively, the alignment target 204 can be a circular mark on an interior surface of a mass spectrometer. In the unaligned state (FIG. 2A), center 206 of the alignment guide 202 and center 210 of the alignment target 204 can be displaced by an offset distance 214. When properly aligned (FIG. 2B), center 206 and center 210 can be superimposed. Generally, for an ion optics stack, the overall alignment needs to be within 50 μm. When the alignment guide 202 and the alignment target 204 are properly configured, the human eye can readily identify an ion optics stack misaligned by more than 50 μm by sighting along the length of the ion optics stack to view the alignment of the alignment guide 202 and the alignment target 204.

In various embodiments, the apparent size of the alignment target 204 relative to the apparent size of the alignment guide 202 can affect the ease at which an ion optics stack that is out of alignment can be identified. An inner circle that is close in size to the outer circle is easier to identify as off center than an inner circle that is significantly smaller than the outer circle. Thus, tighter tolerances can be achieved by increasing the size of the inner circle relative to the outer circle. Inner Circle Percent can be used as a measure of the relative apparent size of the alignment target 204 and alignment guide 202. In various embodiments, the Inner Circle Percent can be not less than about 50%, such as not less than about 80%.

$$InnerCircle \% = \frac{{Diameter}_{Target}}{{Diameter}_{Guide}} \times 100 \qquad 1 )$$

In various embodiments, the size of the offset distance 214 relative to the average gap width (the absolute value of half the difference between the diameters of the outer circle and inner circle) can affect the ease at which an ion optics stack that is out of alignment can be identified. Generally, an offset distance 214 that is closer in size to the average gap width will be more noticeable than an offset distance 214 that is significantly smaller than the average gap width. Gap Offset Ratio can be used as a measure of the relative apparent size of the alignment target 204 and alignment guide 202 when the ion optics stack is in alignment. In various embodiments, the Gap Offset Ratio when the ion optics stack is aligned within tolerance can be not less than about 4, such as not less than about 6.

$$GapOffsetRatio = \frac{Offset}{( {Diameter}_{Guide} - {Diameter}_{Target} ) / 2} \qquad 2 )$$

In various embodiments, the amount of offset distance 214 relative to the diameter 208 of the alignment guide 202 can affect the ease at which an ion optics stack that is out of alignment can be identified. Offset Ratio can be used as a measure of the relative apparent size of the offset and the apparent diameter of the alignment guide 202 when the ion optics stack is in alignment. Thus, tolerances can be reduced by decreasing the size of the outer circle. In various embodiments, the Offset Ratio when the ion optics stack is aligned within tolerance can be not less than about 0.4, such as not less than about 1.2.

$$OffsetRatio = \frac{Offset}{{Diameter}_{Guide}} \qquad 3 )$$

In various embodiments, multiple alignment guides can be used, such as by using multiple lens apertures. This can be helpful in correcting for parallax or identifying which part of an ion optics stack is out of alignment. For example, using a mark on an interior wall as the center most circle and two lens apertures as increasing larger outer circles, one can tell if the alignment is off due to the ion optics stack being misaligned with the rest of the ion path (center circle is offset but two outer circles are aligned), or if the ion optics components are misaligned (two outer circles are offset).

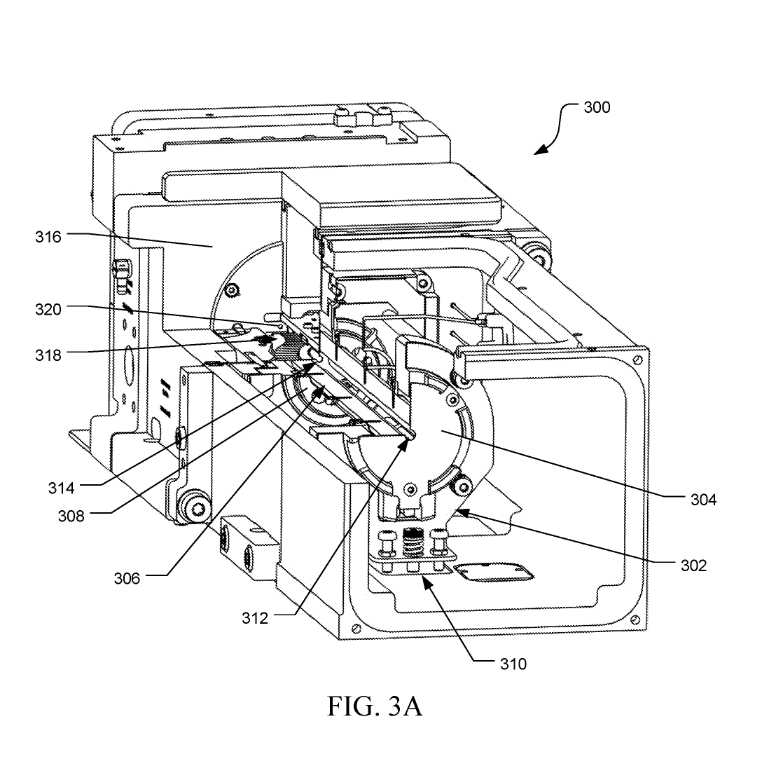

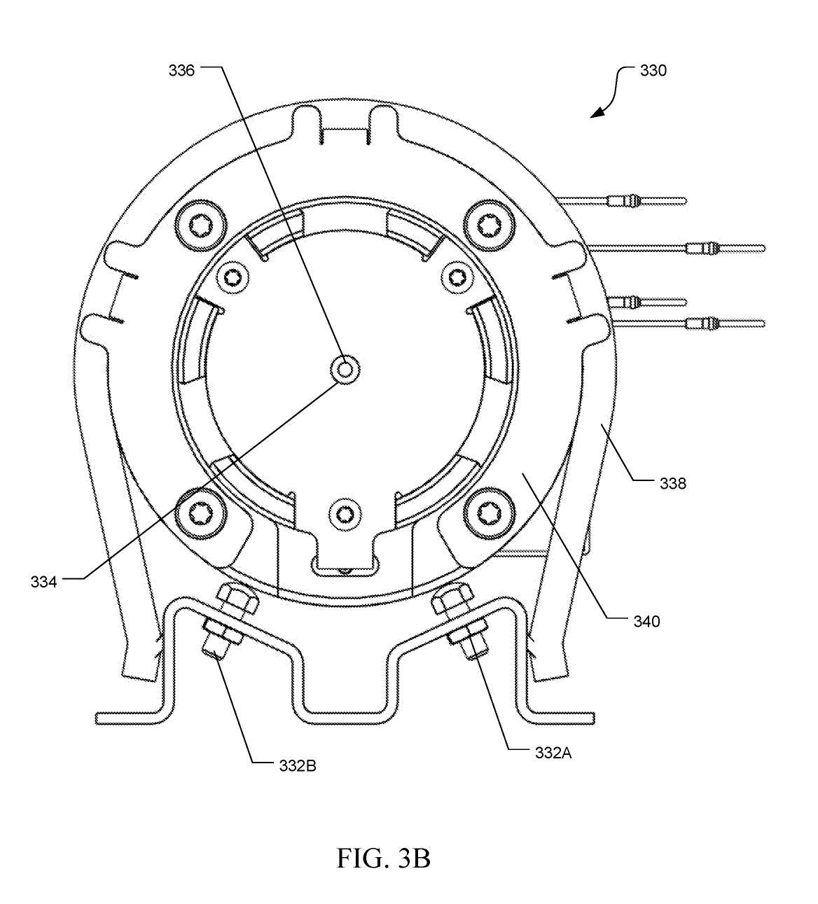

FIG. 3A illustrates an exemplary ion optics stack 302 within a mass spectrometer 300. The ion optics stack 302 can include ion lens 304, a quadrupole 306, ion lens 308, and alignment screws 310. Aperture 312 of ion lens 304 can be used as an alignment guide, and aperture 314 of ion lens 308 can be used as an alignment target when aligning components of the ion optics stack 302 or as an alignment guide when positioning the ion optics stack 302 within mass spectrometer 300.

Mass spectrometer 300 can include an interior wall 316, an ion guide 318, and an alignment target mark 320 on interior wall 316. In various embodiments, the alignment target mark 320 can be a circular line etched or drawn on interior wall 316, or can be formed by forming or machining a circular indentation in interior wall 316. In various embodiments, the alignment between the ion optics stack 302 and the ion guide 318 can be critical to the proper operation of the mass spectrometer 300. Misalignment of the ion optics stack 302 and ion guide 318 can lead significant loss of ion transmission between the ion guide 318 and the ion optics stack 302 resulting in loss of intensity at the detector. Observing the concentricity of the alignment target mark 320 with aperture 312 and aperture 314 can guide aligning the ion optics stack 302 with the ion guide 318.

The alignment can be adjusted with the adjustment screws 310. In the embodiment shown, alignment in the vertical dimension can be adjusted by turning the alignment screws 310. Alignment in the horizontal dimension can be adjusted by moving the assembly sideways taking advantage of some slack in the alignment screw holes.

FIG. 3B shows an alternate embodiment 330 with a different arrangement of alignment screws 332A and 332B. The alignment screws 332A and 332B are oriented in non-parallel directions from one another. Alignment can be adjusted in the different directions until the alignment guide 334 and alignment target 336 appear concentric by adjustment of the appropriate alignment screw 332A or 332B. A spring 338 can wrap around ion optics stack 340 to hold the ion optics stack 340 against the alignment screws 332A and 332B.

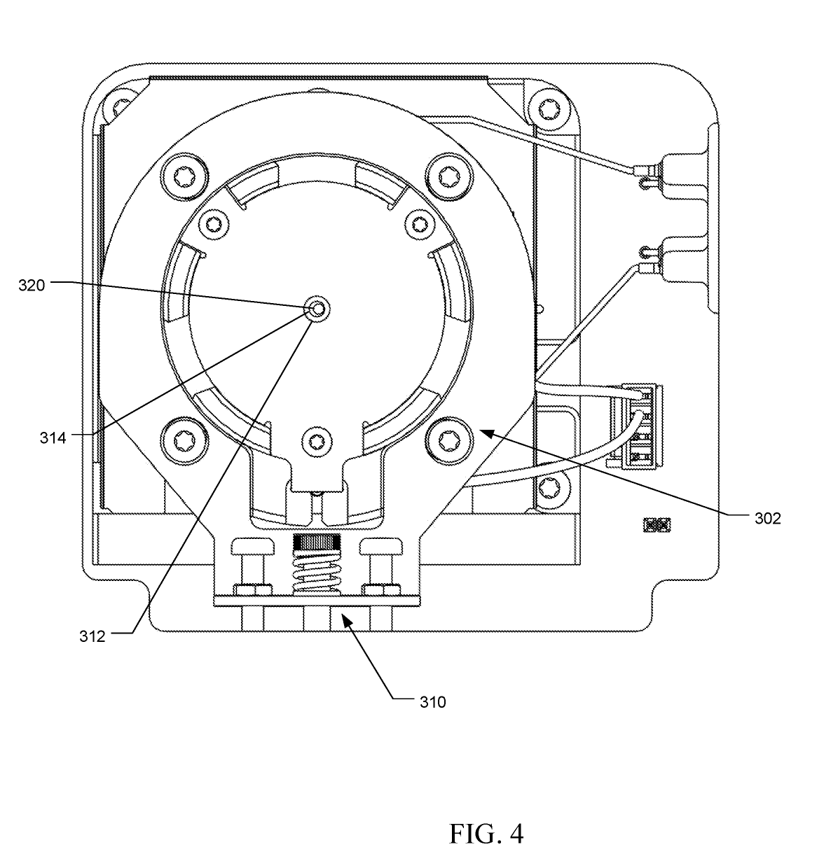

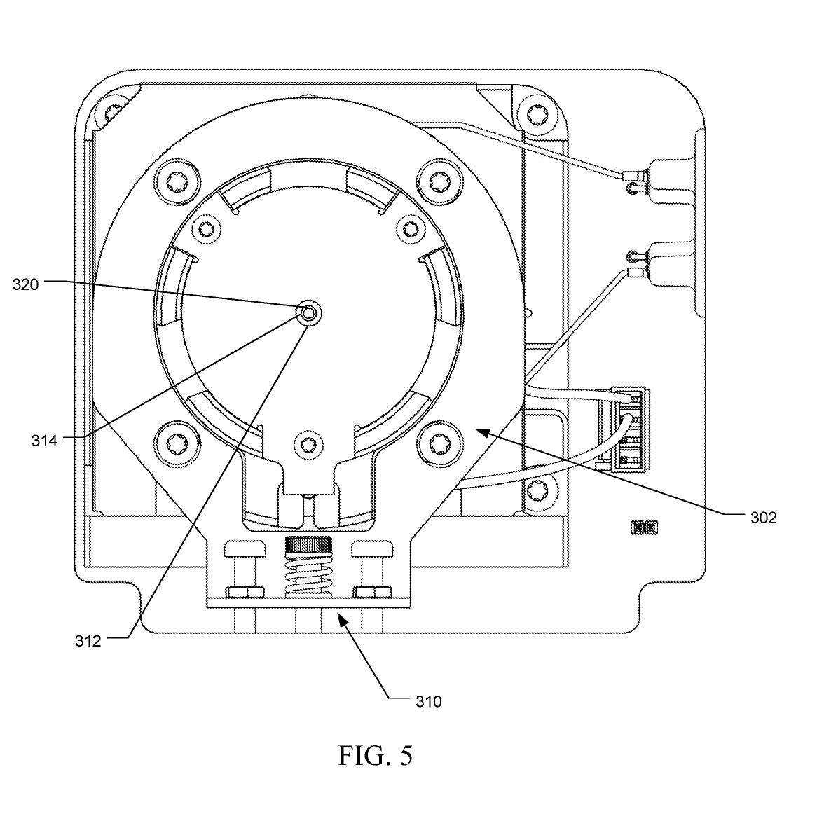

FIG. 4 illustrates the view sighting down the axis of the ion optics stack when the stack is misaligned with the rest of the ion path. FIG. 5 illustrates the view sighting down the axis of the ion optics stack when the stack is properly aligned.

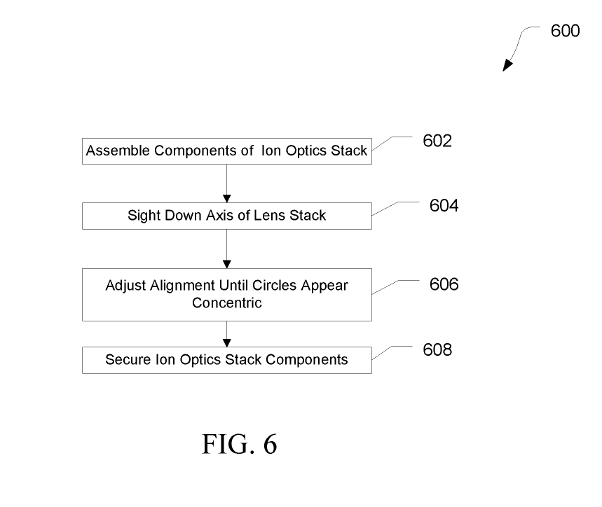

FIG. 6 is a flow diagram illustrating a method 600 of aligning ion optics components within an ion optics stack. The ion optics components can include ion lenses, ion guides, and the like. At 602, the ion optics components can be assembled into an ion optics stack. At 604, an alignment guide and an alignment target can be viewed down the axis of the ion optics stack to determine if the ion optics components are within alignment. In various embodiments, the alignment guide and the alignment target can be apertures for ion lenses. Alternatively, a marking on an assembly jig can be used as an alignment target. At 606, the positioning of the ion optics components can be adjusted, such as by adjusting alignment screws or tension rods, until the alignment guide and alignment target appear to be concentric. Once the ion optics stack is aligned, the ion optics components can be secured to prevent shifting and misalignment of the components, as indicated at 608.

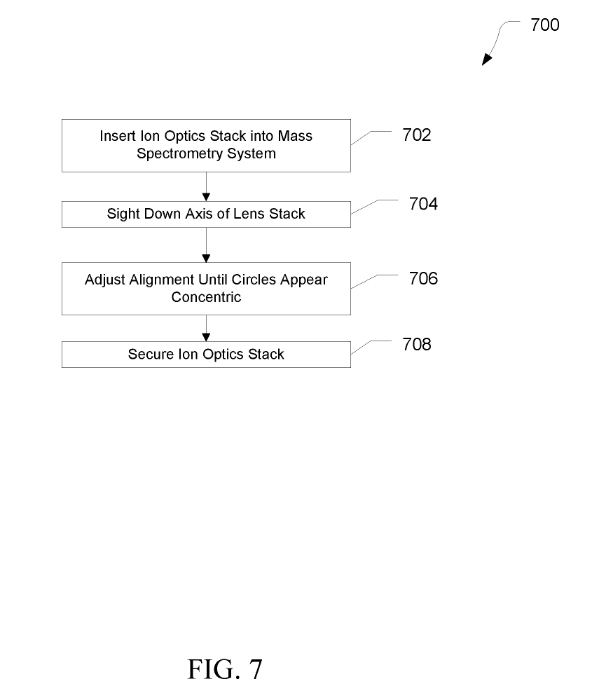

FIG. 7 is a flow diagram illustrating a method 700 of aligning an ion optics stack within a mass spectrometry system. At 702, the ion optics stack can be inserted into the mass spectrometry system. In various embodiments, the ion optics components within the ion optics stack can be pre-aligned, such as by the method disclosed in FIG. 6. At 704, an alignment guide and an alignment target can be viewed down the axis of the ion optics stack to determine if the ion optics stack is aligned within the mass spectrometry system. In various embodiments, the alignment guide can be an aperture of an ion lens and a marking on an internal surface of the mass spectrometry system can be used as an alignment target. At 706, the positioning of the ion optics stack can be adjusted, such as by adjusting alignment screws, until the alignment guide and alignment target appear to be concentric. Once the ion optics stack is aligned within the mass spectrometry system, the ion optics stack can be secured to prevent shifting and misalignment, as indicated at 708.

### Results

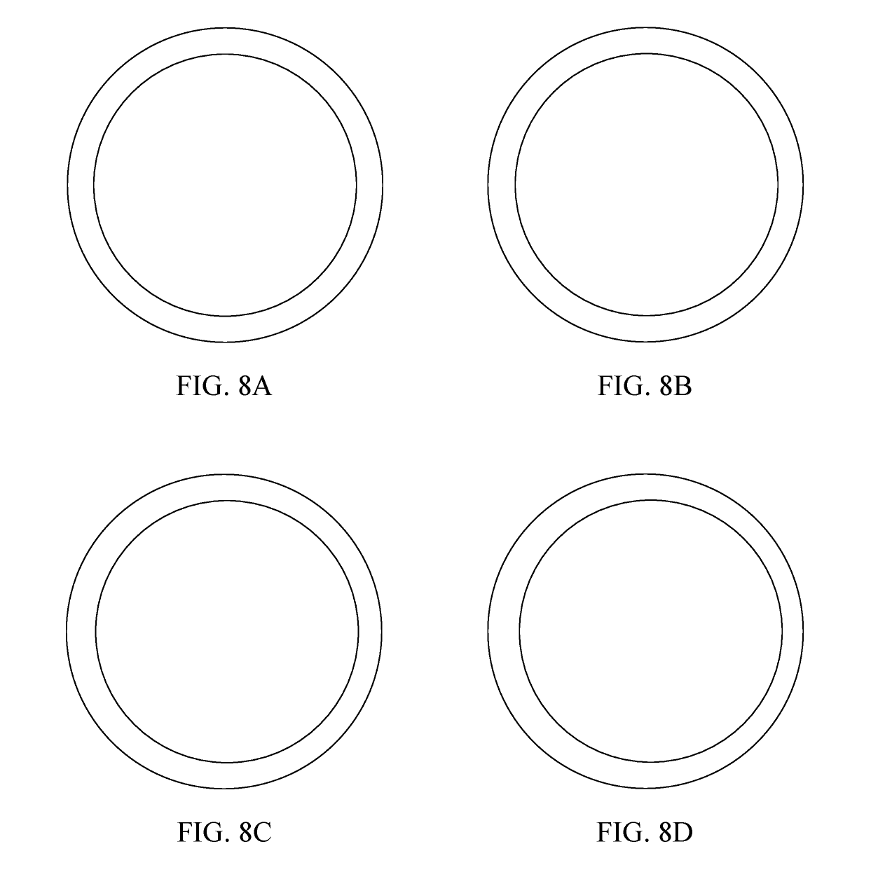

Several tests are performed simulating the relative size and positioning of an alignment guide and an alignment target. FIGS. 8A, 8B, 8C, and 8D are illustrations of alignments used for determining accuracy of alignment. Subjects are asked to view the illustrations and determine if the two circles are aligned or which direction the inner circle is shifted. The size of the circles is selected to simulate the field of vision occupied when viewed down the ion optics stack. FIGS. 8A and 8B correspond to 0 μm and 10 μm offsets, respectively, and subjects had difficulty distinguishing between the aligned and misaligned image. FIG. 8C corresponds to a 30 μm offset. The 30 μm offset is near the limit of detection, but is frequently identified by subjects as misaligned. FIG. 8D corresponds to a 50 μm offset (the tolerance limit used for aligning the ion optics stack) and is readily detectable.

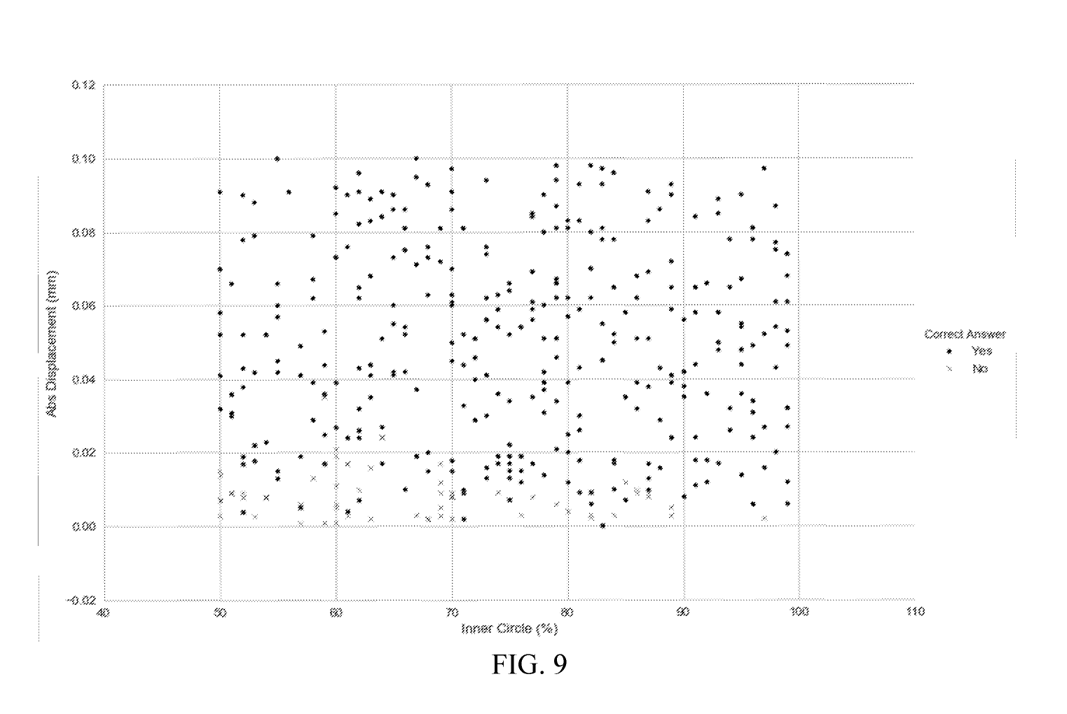

Additional tests are performed to investigate the effect of relative size of the alignment guide and alignment target. Images similar to FIGS. 8A-8D are displayed with various size alignment targets and degrees of misalignment. FIG. 9 and Table 1 show the accuracy of determining the direction of misalignment as a function of relative size of the alignment guide and alignment target. Subjects can accurately identify alignment errors of greater than 50 μm when the diameter of the inner circle is not smaller than 50% of the diameter of the outer circle and errors of greater than 20 μm when the diameter of the inner circle is not smaller than 80% of the diameter of the outer circle.

TABLE 1
Percentage Correct when Identifying Direction of Misalignment
as a Function of Relative Size

| | Inner Circle (%) | | | | |
|---|---|---|---|---|---|
| Offset (μm) | 50-60 | 60-70 | 70-80 | 80-90 | 90-100 |
| 0-10 | 9% | 12% | 19% | 37% | 86% |
| 10-20 | 65% | 36% | 91% | 85% | 100% |
| 20-30 | 71% | 67% | 100% | 100% | 100% |
| 30-40 | 79% | 100% | 100% | 100% | 100% |
| 40-50 | 100% | 100% | 100% | 100% | 100% |
| 50-60 | 100% | 100% | 100% | 100% | 100% |
| 60-70 | 100% | 100% | 100% | 100% | 100% |
| 70-80 | 100% | 100% | 100% | 100% | 100% |

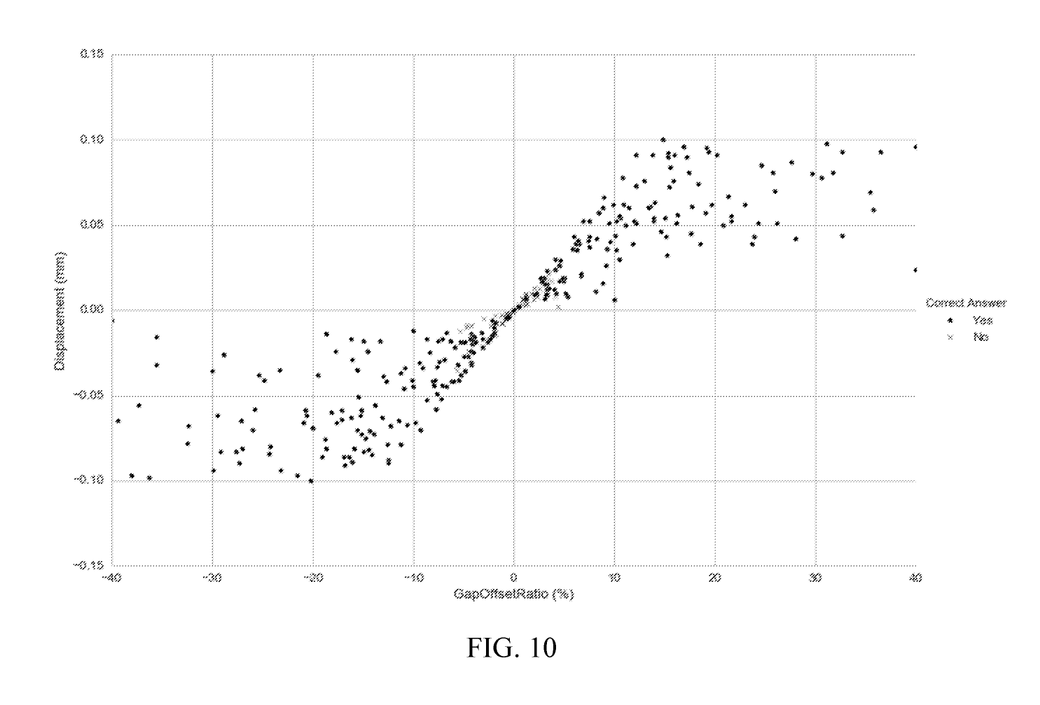

FIG. 10 and Table 2 show the accuracy of determining the direction of misalignment as a function of Gap Offset Ratio when the alignment target is not smaller than 50% of the size of the alignment guide. Subjects can accurately identify alignment errors of greater than 50 μm when the Gap Offset Ratio is not less than about 4 and alignment errors of greater than 20 μm when the Gap Offset Ratio is not less than about 6 for configurations in which the diameter of the inner circle is not smaller than 50% of the diameter of the outer circle.

TABLE 2
Percentage Correct when Identifying Direction of Misalignment
as a Function of Gap Offset Ratio (Inner Circle >=50%)

| | Gap Offset Ratio (%) | | | | |
|---|---|---|---|---|---|
| Offset (μm) | 0-2 | 2-4 | 4-6 | 6-8 | 8-10 |
| 0-10 | 14% | 46% | 33% | | |
| 10-20 | 33% | 65% | 81% | 100% | 100% |
| 20-30 | | 40% | 82% | 100% | 100% |
| 30-40 | | | 81% | 100% | 100% |
| 40-50 | | | 100% | 100% | 100% |
| 50-60 | | | | 100% | 100% |
| 60-70 | | | | | 100% |

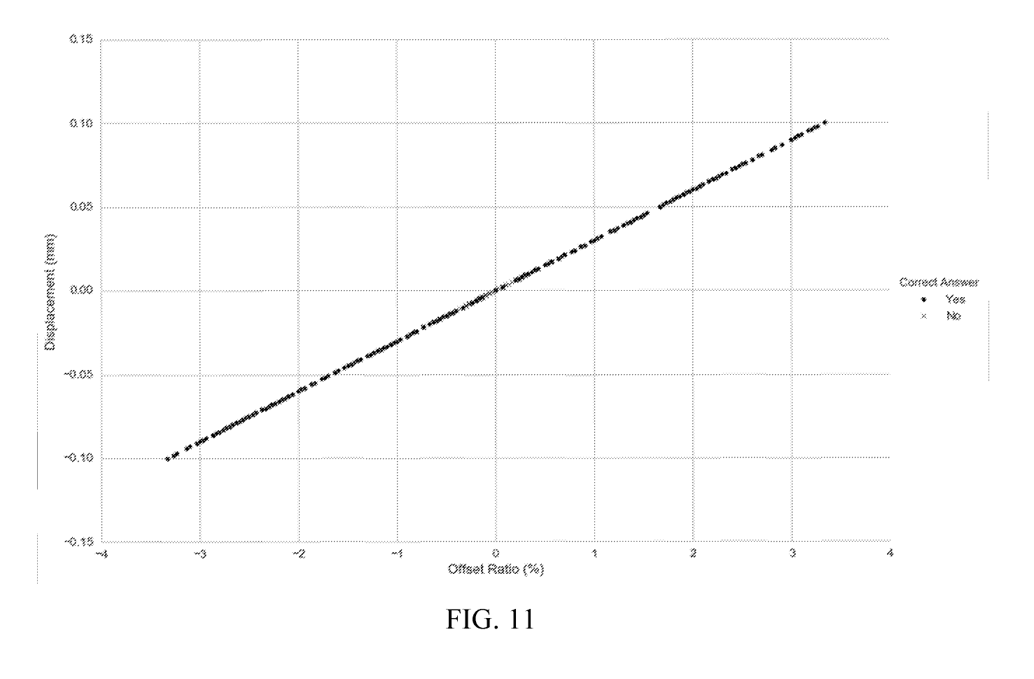

FIG. 11 and Table 3 show the accuracy of determining the direction of misalignment as a function of Offset Ratio when the alignment target is not smaller than 50% of the size of the alignment guide. Table 4 shows the accuracy of determining the direction of misalignment as a function of Offset Ratio when the alignment target is not smaller than 80% of the size of the alignment guide. Subjects can accurately identify alignment errors of greater than 50 μm when the Offset Ratio is greater than 1.2 for configurations in which the diameter of the inner circle is not smaller than 50% of the diameter of the outer circle. Subjects can accurately identify alignment errors of greater than 20 μm when the Offset Ratio is greater than 0.4 for configurations in which the diameter of the inner circle is not smaller than 80% of the diameter of the outer circle.

TABLE 3
Percentage Correct when Identifying Direction of Misalignment
as a Function of Offset Ratio (Inner Circle >=50%)

| | Offset Ratio (%) | | | | |
|---|---|---|---|---|---|
| Offset (μm) | 0.0-0.4 | 0.4-0.8 | 0.8-1.2 | 1.2-1.6 | 1.6-2.0 |
| 0-10 | 24% | | | | |
| 10-20 | 63% | 76% | | | |
| 20-30 | | 77% | 91% | | |
| 30-40 | | | 97% | 91% | |
| 40-50 | | | | 100% | 100% |
| 50-60 | | | | | 100% |

TABLE 4
Percentage Correct when Identifying Direction of Misalignment
as a Function of Offset Ratio (Inner Circle >=80%)

| | Abs Offset Ratio (%) | | | | |
|---|---|---|---|---|---|
| Offset (μm) | 0.0-0.4 | 0.4-0.8 | 0.8-1.2 | 1.2-1.6 | 1.6-2.0 |
| 0-10 | 50% | | | | |
| 10-20 | 75% | 95% | | | |
| 20-30 | | 100% | 100% | | |
| 30-40 | | | 100% | 100% | |
| 40-50 | | | | 100% | 100% |
| 50-60 | | | | | 100% |

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A mass spectrometry system comprising:
an ion optics stack defining a central longitudinal axis, the ion optics stack including:
a circular lens aperture of a first diameter; and
a circular alignment target having a second diameter, the second diameter less than the first diameter,
wherein the circular alignment target is positioned such that when the ion optics stack is in alignment, the circular lens aperture and circular alignment target appear concentric to an unaided viewer when viewed along the central longitudinal axis of the ion optics stack.

2. The mass spectrometry system of claim 1 wherein the alignment target is a circular mark on an interior surface of the mass spectrometry system.

3. The mass spectrometry system of claim 1 wherein the circular lens aperture and the circular alignment target has an Inner Circle Percent of not less than about 50%.

4. (canceled)

5. The mass spectrometry system of claim 1 wherein, when the ion optics stack is in alignment, the circular lens aperture and the circular alignment target have an Offset Ratio of not less than about 0.4.

6. (canceled)

7. The mass spectrometry system of claim 1 wherein, when the ion optics stack is in alignment, the circular lens aperture and the circular alignment target have a Gap Offset Ratio not less than about 4.

8. (canceled)

9. The mass spectrometry system of claim 1 wherein the ion optics stack further includes a second lens aperture and the circular lens aperture, the second lens aperture, and the circular alignment target appear concentric when viewed along the ion optics stack when the ion optics stack is in alignment.

10. A method for aligning an ion optics stack within a mass spectrometry system, comprising:
inserting the ion optics stack into the mass spectrometry system, the ion optics stack including a circular alignment guide and defining a central longitudinal axis, the mass spectrometry system including a circular alignment target; and
adjusting the alignment of the ion optics stack until the alignment guide and the alignment target appear concentric when viewed by an unaided viewer along the central longitudinal axis of the ion optics stack.

11. The method of claim 10 wherein adjusting the alignment of the ion optics stack includes adjusting one or more alignment screws.

12. The method of claim 10 further comprising securing the ion optics stack in the aligned position.

13. The method of claim 10 wherein the circular alignment guide and the circular alignment target have an Inner Circle Percent of not less than about 50%.

14. (canceled)

15. The method of claim 10 wherein adjusting the alignment of the ion optics stack includes adjusting the alignment until the circular alignment guide and the circular alignment target have an Offset Ratio of not less than about 0.4.

16. (canceled)

17. The method of claim 10 wherein adjusting the alignment of the ion optics stack includes adjusting the alignment until the circular alignment guide and the circular alignment target have a Gap Offset Ratio of not less than about 4.

18. (canceled)

19. The method of claim 10 further wherein the circular alignment guide is a lens aperture of the ion optics stack.

20. (canceled)

21. The method of claim 18 further wherein the circular alignment target is a circular mark on an interior surface of the mass spectrometry system.

22. A method for aligning an ion optics stack having a first circular aperture and a second circular aperture displaced from one another along a length of the ion optics stack, the ion optics stack defining a central longitudinal axis, comprising:
adjusting the alignment of the ion optics stack until the first circular aperture and the second circular aperture appear concentric when viewed by an unaided viewer down the central longitudinal axis of the ion optics stack.

23. The method of claim 22 wherein the first circular aperture and the second circular aperture have an Inner Circle Percent of not less than about 50%.

24. (canceled)

25. The method of claim 22 wherein adjusting the alignment of the ion optics stack includes adjusting the alignment until the first circular aperture and the second circular aperture have an Offset Ratio of not less than about 0.4.

26. (canceled)

27. The method of claim 22 wherein adjusting the alignment of the ion optics stack includes adjusting the alignment the first circular aperture and the second circular aperture have a Gap Offset Ratio of not less than about 4.

28. (canceled)

29. The method of claim 22 further wherein the first circular aperture is a first lens aperture of the ion optics stack.

30. The method of claim 22 further wherein the second circular aperture is a second lens aperture of a second ion optics stack.
